(19) United States
(12) Patent Application Publication
(10) Pub. No.: US 2026/0279904 A1
(43) Pub. Date: Sep. 17, 2026

(54) ELECTROLYTE COMPRISING IMIDAZOLIUM IONIC LIQUID AND SOLVENT WITH HIGH BOILING POINT AND BATTERIES COMPRISING SAME

(71) Applicant: Factorial Inc., Billerica, MA (US)

(72) Inventors: Zhangxing Shi, Winchester, MA (US); Yiqing Huang, Lexington, MA (US); Jia Du, Burlington, MA (US); Dong Ren, Woburn, MA (US)

(73) Assignee: Factorial Inc., Billerica, MA (US)

(21) Appl. No.: 19/473,277

(22) PCT Filed: Aug. 22, 2024
(86) PCT No.: PCT/US24/43342

§ 371 Date: Oct. 7, 2025

Related U.S. Application Data
(60) Provisional application No. 63/535,668, filed on Aug. 31, 2023.

(51) Int. Cl. H01M 10/0567; H01M 10/0525; H01M 10/0565; H01M 10/0568; H01M 10/0569

(52) U.S. Cl. CPC H01M 10/0567; H01M 10/0525; H01M 10/0565; H01M 10/0568; H01M 10/0569; H01M 2300/0028; H01M 2300/0082

(57) ABSTRACT

Disclosed is an electrolyte composition comprising a lithium salt, an imidazolium ionic liquid, and an organic solvent with a high boiling point. In one embodiment, the high boiling point is 100° C. or above. The electrolyte and an electrochemical device comprising the same exhibit an improved thermal stability and safety.

### CROSS-REFERENCE

The present application claims priority of U.S. Ser. No. 63/535,668, filed Aug. 31, 2023, the entire content of which is incorporated herein by reference into this application.

### FIELD

Disclosed are electrolytes comprising a lithium salt, an imidazolium ionic liquid, and a solvent with a high boiling point, and an electrochemical device comprising the electrolyte.

### BACKGROUND

Imidazolium ionic liquid such as 1-ethyl-3-methylimidazolium bis(fluorosulfonyl)imide (EmimFSI) is a promising electrolyte solvent due to high solubility of Li salt, excellent electrochemical and chemical stability, and negligible vapor pressure.

However, when EmimFSI is used without other electrolyte solvents, the resulting electrolyte has sluggish Li ion transport and poor rate capability. Fluorinated solvents such as 1,2-difluorobenzene (dFBn) are used as a solvent in imidazolium ionic liquid electrolytes for their low viscosities and high stability. Fluorinated solvents can improve the transport properties of the electrolytes so they can meet the criteria for practical applications and can also promote the formation of LiF-rich solid-electrolyte interface (SEI), which improves the stability of SEI and suppress Li dendrites. However, the conventional fluorinated solvents and cosolvents have a low boiling point (bp). For example, dFBn has a bp of around 92° C. When dFBn is used as a solvent in an EmimFSI electrolyte, the battery comprising the electrolyte may exhibit a less desirable safety profile, especially when the battery experiences a high temperature due to self-heating or external heating. The leaking and venting of electrolyte components with low bp will release hazardous chemicals that are toxic and/or flammable. The leaking and venting process could also lead to explosion of the battery in certain circumstances. Thus, there remains a need for electrolytes with improved battery safety especially at elevated temperatures.

### SUMMARY

The present disclosure provides an electrolyte comprising an imidazolium ionic liquid, a lithium salt and an organic solvent with a high boiling point. In some embodiments, the solvent has a boiling point of at least 110° C. In some embodiments, the imidazolium ionic liquid is 1-ethyl-3-methylimidazolium bis(fluorosulfonyl)imide (EmimFSI). In some embodiments, the lithium salt is lithium bis(fluorosulfonyl)imide (LiFSI). In some embodiments, the imidazolium ionic liquid and the lithium salt share the same anion. In some embodiments, the organic solvent does not comprise ionic structure. In one aspect, an electrochemical device, such as a lithium metal battery, comprising the electrolyte is also disclosed. In one embodiment, the battery exhibits an improved safety profile. Methods for preparing the electrolyte and the lithium metal battery are also disclosed.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows the specific capacities at various charge rates (up to 1.5 C=4.5 mA/cm²) of a coin cell comprising Li metal as anode, NMC811 composite electrode as cathode, microporous membrane as separator, and an electrolyte according to one embodiment of the present disclosure.

FIG. 2 shows the specific capacities at various charge rates (up to 2.5 C=7.5 mA/cm²) of coin cell comprising Li metal as anode, NMC811 composite electrode as cathode, microporous membrane as separator, and an electrolyte according to one embodiment of the present disclosure.

FIG. 3 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 4 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 5 shows the specific capacities at various charge rates (up to 2.0 C=6.0 mA/cm²) of coin cell comprising Li metal as anode, NMC811 composite electrode as cathode, microporous membrane as separator, and an electrolyte according to one embodiment of the present disclosure.

FIG. 6 shows the differential scanning calorimetry (DSC) measurement of electrolyte according to one embodiment of the present disclosure.

FIG. 7 shows a photo of a pouch cell after a hot box test according to one embodiment of the present disclosure.

### DETAILED DESCRIPTION

Disclosed is an electrolyte comprising an imidazolium ionic liquid (alternatively, imidazolium based ionic liquid), a lithium salt and an organic solvent with a high boiling point. In some embodiments, the solvent has a boiling point of at least 100° C. In some embodiments, the electrolyte and an electrochemical device comprising the same exhibit an improved thermal stability and safety, for example having suitable values for one or more of the following: ionic conductivity, average coulombic efficiency, and/or EUCAR (European Council for Automotive Research) hazard level after a hot box test.

In some embodiments, the organic solvent with a high boiling point is not an inorganic or organic salt or an ionic liquid. In some embodiments, the organic solvent does not have an ionic structure. In some embodiments, the electrolyte does not comprise water.

In some embodiments, non-limiting specific organic solvents with a high boiling point (bp) above 100° C. include, but is not limited to 1,2-diethoxyethane (DEE), 1,2-dipropoxyethane (DPE), dibutyl ether (DBE), anisole (AN), diethylene glycol dimethyl ether (DGL), triethylene glycol dimethyl ether (triglyme), tetraethylene glycol dimethyl ether (tetraglyme), 1-fluoronaphthalene (FNP), bis(2,2,2-trifluoroethoxy)methane (BTFM), N,N-dimethyltrifluoromethanesulfonamide (DTSA), N,N-diethyltrifluoromethanesulfonamide (ETSA), 1,2-(1,1,2,2-tetrafluoroethoxy)ethane (TFEE), 1,2-bis(2,2-difluoroethoxy)ethane (BDFE), 2-[2-(2,2-difluoroethoxy)ethoxy]-1,1,1-trifluoroethane (DTFE), tris(2,2,2-trifluoroethyl)orthoformate (TFEO), 1H,1H,5H-octafluoropentyl 1,1,2,2-tetrafluoroethyl ether (OTE), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

In some embodiments, the electrolyte comprises an organic solvent with a concentration in a range from 5 wt % to 70 wt %, from 5 wt % to 60 wt %, from 5 wt % to 50 wt %, from 5 wt % to 45 wt %, from 5 wt % to 40 wt %, from 5 wt % to 35 wt %, from 5 wt % to 30 wt %, from 5 wt % to 25 wt %, from 5 wt % to 20 wt %, from 5 wt % to 17.5 wt %, from 5 wt % to 15 wt %, from 5 wt % to 12.5 wt %, from 5 wt % to 10 wt %, from 6 wt % to 70 wt %, from 6 wt % to 60 wt %, from 6 wt % to 50 wt %, from 6 wt % to 45 wt %, from 6 wt % to 40 wt %, from 6 wt % to 35 wt %, from 6 wt % to 30 wt %, from 6 wt % to 25 wt %, from 6 wt % to 20 wt %, from 6 wt % to 17.5 wt %, from 6 wt % to 15 wt %, from 6 wt % to 12.5 wt %, from 6 wt % to 10 wt %, from 7.5 wt % to 70 wt %, from 7.5 wt % to 60 wt %, from 7.5 wt % to 50 wt %, from 7.5 wt % to 45 wt %, from 7.5 wt % to 40 wt %, from 7.5 wt % to 35 wt %, from 7.5 wt % to 30 wt %, from 7.5 wt % to 25 wt %, from 7.5 wt % to 20 wt %, from 7.5 wt % to 17.5 wt %, from 7.5 wt % to 15 wt %, from 7.5 wt % to 12.5 wt %, from 7.5 wt % to 10 wt %, from 10 wt % to 70 wt %, from 10 wt % to 60 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 10 wt % to 20 wt %, from 10 wt % to 17.5 wt %, from 10 wt % to 15 wt %, or any and all ranges and subranges therebetween.

In some embodiments, the imidazolium ionic liquid comprises one or more imidazolium ionic liquids. In some embodiments, an imidazolium ionic liquid has a general formula:

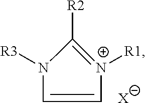

where R1 and R3 are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl, and combination thereof, R2 is selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl, and combination thereof, and X⁻ is an anion. Nonlimiting specific C₁₋₁₈ alkyls include methyl (—CH₃), ethyl (—CH₂CH₃), i-propyl (—CH(CH₃)₂), n-propyl (—CH₂CH₂CH₃), n-butyl (—CH₂[CH₂]₂CH₃), i-butyl (—CH₂CH(CH₃)₂), n-pentyl (—CH₂[CH₂]₃CH₃), n-hexyl (—CH₂[CH₂]₄CH₃), n-heptyl (—CH₂[CH₂]₅CH₃), n-octyl (—CH₂[CH₂]₆CH₃), n-nonyl (—CH₂[CH₂]₇CH₃), n-decyl (—CH₂[CH₂]₈CH₃), n-undecyl (—CH₂[CH₂]₉CH₃), n-dodecyl (—CH₂[CH₂]₁₀CH₃), n-tridecyl (—CH₂[CH₂]₁₁CH₃), n-tetradecyl (—CH₂[CH₂]₁₂CH₃), n-hexadecyl (—CH₂[CH₂]₁₄CH₃), n-octadecyl (—CH₂[CH₂]₁₆CH₃), and any combination thereof.

In some embodiments, the anion X is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), dicyanamide (DCA⁻), nitrate (NO₃⁻), fluoride (F⁻), chloride (Cl⁻), bromide (Br⁻), and a mixture thereof.

In some embodiments, the imidazolium ionic liquids are selected from the group consisting of 1-ethyl-3-methylimidazolium bis(fluorosulfonyl)imide (EmimFSI), 1-butyl-3-methylimidazolium bis(fluorosulfonyl)imide (BmimFSI), 1-hexyl-3-methylimidazolium bis(fluorosulfonyl)imide (HmimFSI), 1-vinyl-3-methylimidazolium bis(fluorosulfonyl)imide (VmimFSI), 1-ethyl-3-methylimidazolium bis(trifluoromethanesulfonyl)imide (EmimTFSI), 1-butyl-3-methylimidazolium bis(trifluoromethanesulfonyl)imide (BmimTFSI), 1-hexyl-3-methylimidazolium bis(trifluoromethanesulfonyl)imide (HmimTFSI), 1-vinyl-3-methylimidazolium bis(trifluoromethanesulfonyl)imide (VmimTFSI), and mixtures thereof.

In some embodiments, the electrolyte comprises an imidazolium ionic liquid with a weight percentage in a range from 10 wt % to 80 wt %, from 10 wt % to 70 wt %, from 10 wt % to 60 wt %, from 10 wt % to 50 wt %, from 10 wt % to 45 wt %, from 10 wt % to 40 wt %, from 10 wt % to 35 wt %, from 10 wt % to 30 wt %, from 20 wt % to 80 wt %, from 20 wt % to 70 wt %, from 20 wt % to 60 wt %, from 20 wt % to 50 wt %, from 20 wt % to 45 wt %, from 20 wt % to 40 wt %, from 20 wt % to 35 wt %, from 20 wt % to 30 wt %, from 30 wt % to 80 wt %, from 30 wt % to 70 wt %, from 30 wt % to 60 wt %, from 30 wt % to 50 wt %, from 30 wt % to 45 wt %, from 30 wt % to 40 wt %, from 35 wt % to 80 wt %, from 35 wt % to 70 wt %, from 35 wt % to 60 wt %, from 35 wt % to 50 wt %, from 35 wt % to 45 wt %, from 35 wt % to 40 wt %, from 40 wt % to 80 wt %, from 40 wt % to 70 wt %, from 40 wt % to 60 wt %, from 40 wt % to 50 wt %, or any and all ranges and subranges therebetween.

In some embodiments, the lithium salt may comprise one or more lithium salts. In one embodiment, the lithium salts are selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}Hz)₆₋ₓ]) (1<x<5, 1<y<8, and 0<z<2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and mixtures thereof.

In some embodiments, the electrolyte comprises a lithium salt with a concentration in a range from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 10 wt % to 20 wt %, from 12.5 wt % to 60 wt %, from 12.5 wt % to 55 wt %, from 12.5 wt % to 50 wt %, from 12.5 wt % to 45 wt %, from 12.5 wt % to 40 wt %, from 12.5 wt % to 35 wt %, from 12.5 wt % to 30 wt %, from 12.5 wt % to 25 wt %, from 12.5 wt % to 20 wt %, from 15 wt % to 60 wt %, from 15 wt % to 55 wt %, from 15 wt % to 50 wt %, from 15 wt % to 45 wt %, from 15 wt % to 40 wt %, from 15 wt % to 35 wt %, from 15 wt % to 30 wt %, from 15 wt % to 25 wt %, from 15 wt % to 20 wt %, from 17.5 wt % to 60 wt %, from 17.5 wt % to 55 wt %, from 17.5 wt % to 50 wt %, from 17.5 wt % to 45 wt %, from 17.5 wt % to 40 wt %, from 17.5 wt % to 35 wt %, from 17.5 wt % to 30 wt %, from 17.5 wt % to 25 wt %, from 17.5 wt % to 20 wt %, from 20 wt % to 60 wt %, from 20 wt % to 55 wt %, from 20 wt % to 50 wt %, from 20 wt % to 45 wt %, from 20 wt % to 40 wt %, from 20 wt % to 35 wt %, from 20 wt % to 30 wt %, from 20 wt % to 25 wt %, or any and all ranges and subranges therebetween.

In some embodiments, the electrolyte may further comprise a non-imidazolium ionic liquid to improve the ionic conductivity, thermal stability, electrochemical performance, stability, and/or safety. In some embodiments, the non-imidazolium ionic liquid is selected from the group consisting of N-propyl-N-methylpyrrolidinium bis(fluorosulfonyl)imide (PYR13FSI), N-butyl-N-methylpyrrolidinium bis(fluorosulfonyl)imide (PYR14FSI), N-propyl-N-methylpiperidinium bis(fluorosulfonyl)imide (PP13FSI), 1-methyl-1-(2-methoxyethyl)pyrrolidinium bis(fluorosulfonyl)imide (PYOFSI), N-propyl-N-methylpyrrolidinium bis(trifluoromethanesulfonyl)imide (PYR13TFSI), N-butyl-N-methylpyrrolidinium bis(trifluoromethanesulfonyl)imide (PYR14TFSI), N-propyl-N-methylpiperidinium bis(trifluoromethanesulfonyl)imide (PP13TFSI), 1-methyl-1-(2-methoxyethyl)pyrrolidinium bis(trifluoromethanesulfonyl)imide (PYOTFSI), and mixtures thereof.

In some embodiments, the electrolyte comprises a non-imidazolium ionic liquid with a concentration in a range from 1.0 wt % to 30 wt %, from 1.0 wt % to 25 wt %, from 1.0 wt % to 20 wt %, from 1.0 wt % to 15 wt %, from 1.0 wt % to 10 wt %, from 1.0 wt % to 7.5 wt %, from 1.0 wt % to 5.0 wt %, from 1.0 wt % to 2.5 wt %, from 1.0 wt % to 2.0 wt %, from 1.5 wt % to 30 wt %, from 1.5 wt % to 25 wt %, from 1.5 wt % to 20 wt %, from 1.5 wt % to 15 wt %, from 1.5 wt % to 10 wt %, from 1.5 wt % to 7.5 wt %, from 1.5 wt % to 5.0 wt %, from 1.5 wt % to 2.5 wt %, from 1.5 wt % to 2.0 wt %, from 2.0 wt % to 30 wt %, from 2.0 wt % to 25 wt %, from 2.0 wt % to 20 wt %, from 2.0 wt % to 15 wt %, from 2.0 wt % to 10 wt %, from 2.0 wt % to 7.5 wt %, from 2.0 wt % to 5.0 wt %, from 2.0 wt % to 2.5 wt %, from 5.0 wt % to 30 wt %, from 5.0 wt % to 25 wt %, from 5.0 wt % to 20 wt %, from 5.0 wt % to 15 wt %, from 5.0 wt % to 10 wt %, from 5.0 wt % to 7.5 wt %, or any and all ranges and subranges therebetween.

In some embodiments, the imidazolium based ionic liquid is 1-ethyl-3-methylimidazolium bis(fluorosulfonyl)imide (EmimFSI). In one embodiment, the lithium salt is lithium bis(fluorosulfonyl)imide (LiFSI).

In some embodiments, the imidazolium based ionic liquid and the lithium salt share the same anion. In some embodiments, the solvent is an organic solvent and/or does not comprise ionic structure.

In some embodiments, the electrolyte comprises 1-ethyl-3-methylimidazolium bis(fluorosulfonyl)imide (EmimFSI), lithium bis(fluorosulfonyl)imide (LiFSI), and a solvent with a high boiling point.

In some embodiments, a high boiling point is no less than 100° C., no less than 105° C., no less than 110° C., no less than 120° C., no less than 130° C., no less than 140° C., no less than 150° C., no less than 150° C., no less than 160° C., no less than 170° C. or no less than 180° C. The boiling point is measured at 760 mm Hg unless otherwise specified.

In some embodiments, the electrolyte further comprises a polymer to improve the thermal stability and/or safety. In some embodiments, the polymer is added into a mixture containing an imidazolium ionic liquid, a lithium salt, and an organic solvent with such high bp.

In some embodiments, the electrolyte comprises a polymer with a concentration in a range from 0.01 wt % to 20 wt %, from 0.01 wt % to 15 wt %, from 0.01 wt % to 10 wt %, from 0.01 wt % to 5.0 wt %, from 0.01 wt % to 2.5 wt %, from 0.01 wt % to 2.0 wt %, from 0.01 wt % to 1.5 wt %, from 0.01 wt % to 1.0 wt %, from 0.05 wt % to 20 wt %, from 0.05 wt % to 15 wt %, from 0.05 wt % to 10 wt %, from 0.05 wt % to 5.0 wt %, from 0.05 wt % to 2.0 wt %, from 0.05 wt % to 1.5 wt %, from 0.05 wt % to 1.0 wt %, from 0.1 wt % to 20 wt %, from 0.1 wt % to 15 wt %, from 0.1 wt % to 10 wt %, from 0.1 wt % to 5.0 wt %, from 0.1 wt % to 2.0 wt %, from 0.1 wt % to 1.5 wt %, from 0.1 wt % to 1.0 wt %, from 0.25 wt % to 20 wt %, from 0.25 wt % to 15 wt %, from 0.25 wt % to 10 wt %, from 0.25 wt % to 5.0 wt %, from 0.25 wt % to 2.0 wt %, from 0.25 wt % to 1.5 wt %, from 0.25 wt % to 1.0 wt %, from 0.5 wt % to 20 wt %, from 0.5 wt % to 15 wt %, from 0.5 wt % to 10 wt %, from 0.5 wt % to 5.0 wt %, from 0.5 wt % to 2.0 wt %, from 0.5 wt % to 1.5 wt %, from 0.5 wt % to 1.0 wt %, or any and all ranges and subranges therebetween.

In some embodiments, the polymer is in situ polymerized after a monomer and initiator is mixed with an imidazolium ionic liquid, a lithium salt, and a solvent. When an electrolyte comprises a polymer, the electrolyte is referred to as polymer electrolyte.

In some embodiments, the polymer electrolyte is prepared by an in situ polymerization in the presence of an initiator such as azobisisobutyronitrile (AIBN), ammonium persulfate (APS), potassium persulfate (PPS), sodium persulfate (SPS), and lithium persulfate (LPS). In some embodiments, the polymer electrolyte is prepared by an in situ polymerization in the presence of an initiator that does not generate gas during the polymerization. Such a non-gas generating initiator is an initiator that does not have any groups leading to gas formation during the polymerization.

In some embodiments, the initiator is a persulfate. In some embodiments, a persulfate initiator comprises an anion of SO₅²⁻, S₂O₈²⁻, or both. In some embodiments, non-limiting specific persulfate initiators include ammonium persulfate (APS), potassium persulfate (PPS), sodium persulfate (SPS), lithium persulfate (LPS) and any combination thereof. In some embodiments, the electrolyte composition does not include gas generating initiators, such as azobisisobutyronitrile (AIBN) and benzoyl peroxide (BPO).

In some embodiments, the mixture prior to in situ polymerization contains an initiator in an amount from 0.001 wt % to 10 wt %. In some embodiments, the mixture contains an initiator in an amount from 0.002 wt % to 10 wt %, from 0.005 wt % to 10 wt %, from 0.01 wt % to 10 wt %, from 0.02 wt % to 10 wt %, from 0.05 wt % to 10 wt %, from 0.1 wt % to 10 wt %, from 0.2 wt % to 10 wt %, from 0.5 wt % to 10 wt %, from 1.0 wt % to 10 wt %, from 2.0 wt % to 10 wt % or any and all ranges and subranges therebetween.

In some embodiments, the monomer contains one or more polymerizable groups. In some embodiments, non-limiting specific polymerizable groups include vinyl (—CH═CH₂), substituted vinyl (—CR₁═CR₂R₃) and a combination thereof, wherein R1, R2 and R3 are independently hydrogen, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl or any combination thereof. Non-limiting specific monomers include 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=500-5000), triethylene glycol dimethacrylate (TEGDMA), diurethane dimethacrylate, and any combination thereof.

In some embodiments, non-limiting monomers are one or more selected from tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, and dipentaerythritol hexaacrylate.

In some embodiments, the polymer electrolyte is prepared from a mixture containing multiple monomers.

In some embodiments, the monomer is mixed with a lithium salt, an imidazolium ionic liquid, and a solvent with a high boiling point to form a mixture. In some embodiments, the mixture contains the monomer with a concentration in a range from 0.01 wt % to 20 wt %, from 0.01 wt % to 15 wt %, from 0.01 wt % to 10 wt %, from 0.01 wt % to 5.0 wt %, from 0.01 wt % to 2.5 wt %, from 0.01 wt % to 2.0 wt %, from 0.01 wt % to 1.5 wt %, from 0.01 wt % to 1.0 wt %, from 0.05 wt % to 20 wt %, from 0.05 wt % to 15 wt %, from 0.05 wt % to 10 wt %, from 0.05 wt % to 5.0 wt %, from 0.05 wt % to 2.0 wt %, from 0.05 wt % to 1.5 wt %, from 0.05 wt % to 1.0 wt %, from 0.1 wt % to 20 wt %, from 0.1 wt % to 15 wt %, from 0.1 wt % to 10 wt %, from 0.1 wt % to 5.0 wt %, from 0.1 wt % to 2.0 wt %, from 0.1 wt % to 1.5 wt %, from 0.1 wt % to 1.0 wt %, from 0.25 wt % to 20 wt %, from 0.25 wt % to 15 wt %, from 0.25 wt % to 10 wt %, from 0.25 wt % to 5.0 wt %, from 0.25 wt % to 2.0 wt %, from 0.25 wt % to 1.5 wt %, from 0.25 wt % to 1.0 wt %, from 0.5 wt % to 20 wt %, from 0.5 wt % to 15 wt %, from 0.5 wt % to 10 wt %, from 0.5 wt % to 5.0 wt %, from 0.5 wt % to 2.0 wt %, from 0.5 wt % to 1.5 wt %, from 0.5 wt % to 1.0 wt %, or any and all ranges and subranges therebetween.

In some embodiments, the electrolyte comprises 15 wt % to 40 wt % lithium salt, 40 wt % to 70 wt % imidazolium ionic liquid, and 5 wt % to 35 wt % solvent. In some embodiments, the solvent is a mixture comprising at least one solvent with a high boiling point (100° C. or higher). In some embodiments, the solvent is a mixture comprising at least one solvent with a high boiling point (105° C. or higher). In some embodiments, the solvent is a mixture comprising at least one solvent with a high boiling point (110° C. or higher).

In some embodiments, the electrolyte as disclosed herein exhibits a good ionic conductivity. In some embodiments, the electrolyte as disclosed herein exhibits an ionic conductivity of 1.0 mS/cm or higher, 2.0 mS/cm or higher, 2.5 mS/cm or higher, 3.0 mS/cm or higher, 3.5 mS/cm or higher, 4.0 mS/cm or higher, 4.5 mS/cm or higher, 5.0 mS/cm or higher, 5.5 mS/cm or higher, 6.0 mS/cm or higher, 6.5 mS/cm or higher, or 7.0 mS/cm or higher at room temperature.

In some embodiments, the electrolyte as disclosed herein exhibits an improved thermal stability in comparison to the one comprising a solvent with a boiling point of less than 100° C. In one embodiment, the electrolyte as disclosed herein does not exhibit any exothermic or endothermic peak in a differential scanning calorimetry (DSC) curve in a range from room temperature to 100° C. (excluding the peak at the beginning of DSC scanning caused by the DSC system coming to equilibrium). In one embodiment, the electrolyte as disclosed herein does not exhibit any exothermic or endothermic peak in a DSC curve in a range from room temperature to 105° C. In one embodiment, the electrolyte as disclosed herein does not exhibit any exothermic or endothermic peak in a DSC curve in a range from room temperature to 110° C. Whether a reversible peak is exothermic or endothermic depends on the scanning direction.

In some embodiments, the electrolyte does not include any solvent that has a boiling point less than 100° C., less than 105° C., less than 110° C., or less than 120° C. In some embodiments, the electrolyte does not include 1,2-difluorobenzene (dFBn) or fluorobenzene (FBn).

In some embodiments, the electrolyte further comprises an additive with a weight percentage of 25 wt % or less, 20 wt % or less, 15 wt % or less, 10 wt % or less, 7.5 wt % or less, 5.0 wt % or less, or 2.5 wt % or less. In some embodiments, the additive has a boiling point less than 100° C., less than 105° C., less than 110° C., or less than 120° C., including but not limited to, fluorinated compounds such as 1,2-difluorobenzene (dFBn) and fluorobenzene (FBn).

In one aspect, the present disclosure provides an electrochemical device such as lithium metal battery comprising the electrolyte. In some embodiments, the battery also comprises a lithium metal anode, a separator, and a cathode layer. In one embodiment, the lithium metal anode comprises lithium metal or an alloy of lithium metal.

In some embodiments, an electrochemical device comprising the electrolyte exhibits an improved cycling performance. In some embodiments, the electrochemical device comprising an electrolyte disclosed herein has an average Coulombic efficiency (CE) of no less than 98.00%, no less than 98.25%, no less than 98.50%, no less than 98.75%, no less than 99.00%, no less than 99.10%, no less than 99.15%, no less than 99.20%, no less than 99.2⁵%, no less than 99.30%, or no less than 99.35%.

In some embodiments, an electrochemical device comprises an electrolyte with a good ionic conductivity (1.0 mS/cm or higher, 2.0 mS/cm or higher, 2.5 mS/cm or higher, 3.0 mS/cm or higher, 3.5 mS/cm or higher, 4.0 mS/cm or higher, 4.5 mS/cm or higher, 5.0 mS/cm or higher, 5.5 mS/cm or higher, 6.0 mS/cm or higher, 6.5 mS/cm or higher, or 7.0 mS/cm or higher at room temperature) and simultaneously exhibits a desirable average CE, which can be no less than 98.00%, no less than 98.25%, no less than 98.50%, no less than 98.75%, no less than 99.00%, no less than 99.10%, no less than 99.15%, no less than 99.20%, no less than 99.25%, no less than 99.30%, or no less than 99.35%.

In one embodiment, an electrochemical device comprising the electrolyte as disclosed herein exhibits an improved thermal stability and safety. Out of many ways, battery safety can be characterized by a hot box test. In general, a fully charged electrochemical device (100 state-of-charge) is placed into an oven in which the temperature of the electrochemical device such as a cell is heated from room temperature to a desired high temperature (such as 190° C.) at a rate of 5° C./minute and with a holding of 10 min at each of the following temperatures: 130° C., 140° C., 150° C., 160° C., 170° C., 180° C., and 190° C.

In some embodiments, after the hot box test, the electrochemical device does not experience electrolyte leakage, weight loss, explosion, and/or has a European Council for Automotive Research (EUCAR) hazard level of 4 or below or 3 or below.

TABLE 1
European Council for Automotive Research Hazard Levels

| Hazard | | |
|---|---|---|
| Level | Description | Classification Criteria |
| 0 | No effect | No effect. No loss of functionality |
| 1 | Passive | No defect; no leakage; no venting; no fire |
| | protection | or flame; no rupture; no explosion; no |
| | activated | exothermic reaction or thermal runaway. |
| | | Cell irreversibly damaged. Repair is needed |
| 2 | Defect/Damage | No leakage; no venting; no fire or flame; |
| | | no rupture; no explosion; no exothermic |
| | | reaction or thermal runaway. Cell |
| | | irreversibly damaged. Repair is needed |
| 3 | Leakage, Δ | No venting; no fire or flame; no rupture; |
| | mass <50% | no explosion; weight loss <50% of |
| | | electrolyte weight (electrolyte = |
| | | salt + solvent) |
| 4 | Venting, Δ | No fire or flame; no rupture; no explosion; |
| | mass ≥50% | weight loss ≥50% of electrolyte weight |
| | | (electrolyte = salt + solvent) |
| 5 | Fire or Flame | No rupture; no explosion (e.g., no flying parts) |
| 6 | Rupture | No explosion; but flying parts of the |
| | | active mass |
| 7 | Explosion | Explosion (e.g., disintegration of the cell) |

In some embodiments, after the hot box test, the electrochemical device undergoes a weight loss of 40 wt % or less, 45 wt or less, or less than 50 wt %, based on the total weight of electrolyte in the electrochemical device.

In some embodiments, the electrochemical device passes a hotbox test with a European Council for Automotive Research (EUCAR) hazard level of 4 or below or 3 or below. The EUCAR hazard level is shown in Table 1.

In some embodiments, the electrochemical device is a coin cell, a pouch cell, or a prismatic cell.

In another aspect, the present disclosure provides a method for preparing an electrochemical device comprising an electrolyte with solvents or co-solvents with a boiling point of at least 100° C., at least 105° C. or at least 110° C. In some embodiments, all components in the electrolyte including all solvents have a boiling point of at least 100° C., at least 105° C. or at least 110° C. In some embodiments, the electrochemical device comprises an anode layer, a separator, and a cathode layer. In some embodiments, the method comprises: mixing EmimFSI, LiFSI, the solvent with a bp of at least 100° C., at least 105° C. or at least 110° C. into an electrolyte.

In some embodiments, the disclosure provides a method for preparing an electrochemical device comprising an anode layer, a separator, a cathode layer, and an electrolyte as disclosed herein. In one embodiment, the method may comprise:
1) mixing an imidazolium ionic liquid, a lithium salt, and a solvent with a high boiling point into an electrolyte;
2) placing the anode layer, the separator, and the cathode layer into an assembly;
3) injecting the electrolyte into the assembly, thus forming an electrochemical device comprising the anode layer, the separator, the cathode layer and the electrolyte.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

Li stripping/plating coulombic efficiency (CE) is a critical parameter for the evaluation of electrolyte stability on Li metal anode. The Li stripping/plating CE was obtained by stripping/plating cycles in Li/Cu cells comprising Li metal as anode, Cu foil as cathode, microporous membrane as a separator, and an electrolyte with a composition in Table 2 prepared by mixing the lithium salt, the imidazolium ionic liquid, and the solvent.

The ionic conductivity of the electrolyte is calculated based on the bulk resistance obtained by electrochemical impedance spectroscopy (EIS) measurements at room temperature. As shown in Table 2, electrolytes comprising 1,2-diethoxyethane (DEE) with a boiling point (bp) of 121° C. show high conductivity and high CE, which are crucial for fast charge and long cycle life of Li metal battery.

TABLE 2
Electrolyte compositions according to some
embodiments of the present disclosure

| Ex. | LiFSI | EmimFSI | DEE | IC | Initial | Average |
|---|---|---|---|---|---|---|
| No. | (wt %) | (wt %) | (wt %) | (mS/cm) | CE, % ^{a} | CE, % ^{b} |
| 1-1 | 37.4 | 50.1 | 12.5 | 7.35 | 96.44 ± 0.38 | 99.35 ± 0.07 |
| 1-2 | 31.8 | 54.6 | 13.6 | 9.48 | 96.82 ± 0.29 | 99.04 ± 0.06 |

^{a} initial CE is initial Li stripping capacity divided by initial Li plating capacity.
^{b} average CE is total Li stripping cycle capacity divided by total Li plating cycle capacity using current density of 1.5 mA/cm² and capacity of 3.0 mAh/cm² [Adv. Energy Mater. 2017, 1702097].

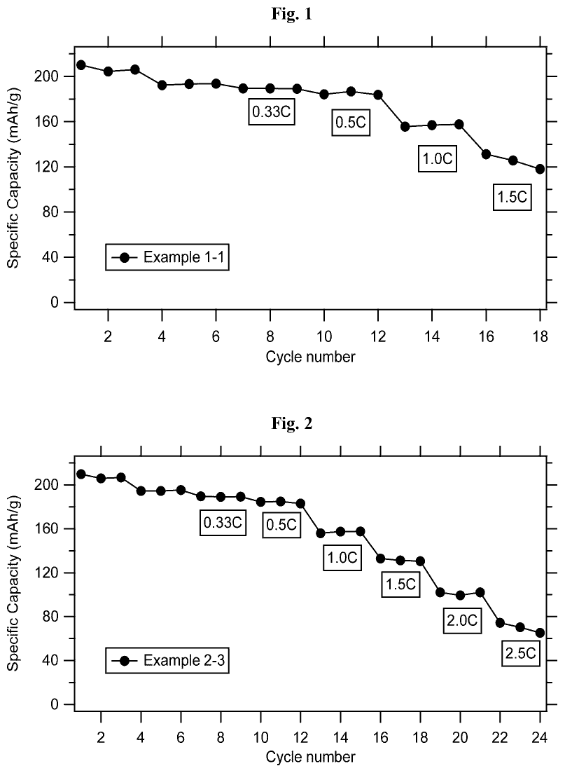

As shown in Table 2, the electrolytes of examples 1-1 and 1-2 exhibit an ionic conductivity (IC) of 7.35 mS/cm and 9.48 mS/cm, respectively. Lithium metal batteries comprising the electrolytes exhibits an average coulombic efficiency (CE) of 99.35% and 99.04%, respectively. FIG. 1 shows the specific capacities at various charge rates (1.0 C=3.0 mAh/cm², up to 4.5 mA/cm2) of a coin cell comprising Li metal as anode, NMC811 composite electrode as cathode, microporous membrane as separator, and an electrolyte of Example 1-1 (Ex. No. 1-1).

### Example 2

In this example, electrolytes were prepared and tested similar to Example 1 except that the compositions are shown in Table 3. Note that the solvent is DEE with dFBn as additive (boiling point of 92° C.) and dFBn has a weight percentage of 10 wt % or less.

A differential scanning calorimetry (DSC) analysis was also conducted by scanning from 25 to 300° C. at a rate of 5° C./min in an atmosphere of Argon.

TABLE 3
Electrolyte compositions according to some
embodiments of the present disclosure

| Ex. | LiFSI | EmimFSI | DEE | DFBn | IC | Initial | Average |
|---|---|---|---|---|---|---|---|
| No. | (wt %) | (wt %) | (wt %) | (wt %) | (mS/cm) | CE, % | CE, % |
| 2-1 | 21.1 | 65.8 | 6.7 | 6.4 | 10.83 | 97.21 ± 0.28 | 99.24 ± 0.04 |
| 2-2 | 28.7 | 49.1 | 12.2 | 10.0 | 11.00 | 96.84 ± 0.21 | 99.27 ± 0.03 |
| 2-3 | 33.7 | 45.1 | 11.2 | 10.0 | 9.18 | 96.80 ± 0.24 | 99.45 ± 0.06 |

As shown in Table 3, the electrolytes of examples 2-1, 2-2, and 2-3 exhibit an IC of 10.83 mS/cm, 11.00 mS/cm, and 9.18 mS/cm, respectively. Lithium metal batteries comprising the electrolytes exhibit an average coulombic efficiency (CE) of 99.24%, 99.27%, and 99.45%, respectively. FIG. 2 shows the specific capacities at various charge rates (1.0 C=3.0 mAh/cm², up to 7.5 mA/cm²) of a coin cell comprising Li metal as anode, NMC811 composite electrode as cathode, microporous membrane as separator, and an electrolyte of Example 2-3. (Ex. No. 2-3).

FIG. 6 shows a DSC curve of example 2-3 in the presence of Li metal. There is no obvious exothermic or endothermic peak observed below 180° C. (melting point of Li metal). It strongly suggests an improved thermal stability of the electrolyte. The peak at the beginning of DSC scanning is attributed to the equilibrium of the DSC system and it is not related to the exothermic or endothermic peak of the electrolyte.

### Example 3

In this example, electrolytes were prepared and tested similar to Example 1 except that the compositions are shown in Table 4. The solvent anisole (AN) has a bp of 153.8° C.

As shown in Table 4, the electrolytes of examples 3-1, 3-2 and 3-3 exhibit an IC of 11.91 mS/cm, 12.00 mS/cm, and 8.52 mS/cm, respectively. Lithium metal batteries comprising the electrolytes exhibit an average coulombic efficiency (CE) of 99.42%, 99.35%, and 99.31%, respectively.

TABLE 4
Electrolyte compositions according to some
embodiments of the present disclosure

| Ex. | LiFSI | EmimFSI | AN | IC | Initial | Average |
|---|---|---|---|---|---|---|
| No. | (wt %) | (wt %) | (wt %) | (mS/cm) | CE, % | CE, % |
| 3-1 | 22.7 | 70.7 | 6.6 | 11.91 | 96.74 ± 0.31 | 99.42 ± 0.02 |
| 3-2 | 21.3 | 66.4 | 12.3 | 12.00 | 97.16 ± 0.69 | 99.35 ± 0.03 |
| 3-3 | 19.0 | 59.1 | 21.9 | 8.52 | 97.50 ± 0.27 | 99.31 ± 0.03 |

### Example 4

In this example, electrolytes were prepared and tested similar to Example 1 except that the compositions are shown in Table 5. Note that the solvent is a mixture of DEE and AN.

TABLE 5
Electrolyte compositions according to some
embodiments of the present disclosure

| Ex. | LiFSI | EmimFSI | DEE | AN | IC | Initial | Average |
|---|---|---|---|---|---|---|---|
| No. | (wt %) | (wt %) | (wt %) | (wt %) | (mS/cm) | CE, % | CE, % |
| 4-1 | 33.7 | 45.1 | 11.2 | 10.0 | 9.29 | 96.92 ± 0.60 | 99.41 ± 0.05 |
| 4-2 | 28.7 | 49.1 | 12.2 | 10.0 | 13.22 | 97.43 ± 0.09 | 99.15 ± 0.04 |

As shown in Table 5, the electrolytes of examples 4-1 and 4-2 exhibit an ionic conductivity (IC) of 9.29 mS/cm and 13.22 mS/cm, respectively. Lithium metal batteries comprising the electrolytes exhibit an average CE of 99.41% and 99.15%, respectively.

### Example 5

In this example, electrolytes were prepared and tested similar to Example 1 except that the compositions are shown in Table 6. The solvent 1-fluoronaphthalene (FNP) has a boiling point of 215° C.

As shown in Table 6, the electrolytes of examples 5-1, 5-2 and 5-3 exhibit an IC of 8.23 mS/cm, 7.03 mS/cm and 3.88 mS/cm, respectively. Lithium metal batteries comprising the electrolytes exhibit an average coulombic efficiency (CE) of 98.67%, 98.15%, and 98.66%, respectively.

TABLE 6
Electrolyte compositions according to some
embodiments of the present disclosure

| Ex. | LiFSI | EmimFSI | FNP | IC | Initial | Average |
|---|---|---|---|---|---|---|
| No. | (wt %) | (wt %) | (wt %) | (mS/cm) | CE, % | CE, % |
| 5-1 | 22.2 | 69.1 | 8.7 | 8.23 | 92.73 ± 0.70 | 98.67 ± 0.07 |
| 5-2 | 20.4 | 63.6 | 16.0 | 7.03 | 93.27 ± 0.84 | 98.15 ± 0.26 |
| 5-3 | 33.7 | 56.3 | 10.0 | 3.88 | 93.40 ± 0.23 | 98.66 ± 0.27 |

### Example 6

In this example, electrolytes were prepared and tested similar to Example 1 except that the compositions are shown in Table 7. The solvent N,N-dimethyltrifluoromethanesulfonamide (DTSA) has a boiling point of 116.9° C.

TABLE 7
Electrolyte compositions according to some
embodiments of the present disclosure

| Ex. | LiFSI | EmimFSI | DTSA | IC | Initial | Average |
|---|---|---|---|---|---|---|
| No. | (wt %) | (wt %) | (wt %) | (mS/cm) | CE, % | CE, % |
| 6-1 | 37.4 | 50.1 | 12.5 | 4.12 | 96.20 ± 0.63 | 99.53 ± 0.06 |

As shown in Table 7, the electrolyte example 6-1 exhibits an IC of 4.12 mS/cm. Lithium metal battery comprising the electrolyte exhibits an average CE of 99.53%.

### Example 7

In this example, electrolytes were prepared and tested similar to Example 1 except that the compositions are shown in Table 8. Note that DTSA and dFBn are used as solvents and that dFBn has a concentration of 20 wt % or less.

As shown in Table 8, the electrolytes of examples 7-1, 7-2 and 7-3 exhibit an IC of 10.83 mS/cm, 9.94 mS/cm and 10.75 mS/cm, respectively. Lithium metal batteries comprising the electrolytes exhibit an average CE of 99.36%, 99.34%, and 99.36%, respectively.

TABLE 8
Electrolyte compositions according to some
embodiments of the present disclosure

| Ex. | LiFSI | EmimFSI | DTSA | dFBn | IC | Initial | Average |
|---|---|---|---|---|---|---|---|
| No. | (wt %) | (wt %) | (wt %) | (wt %) | (mS/cm) | CE, % | CE, % |
| 7-1 | 20.1 | 62.6 | 12.3 | 5.0 | 10.83 | 97.93 ± 0.11 | 99.36 ± 0.01 |
| 7-2 | 19.1 | 59.3 | 11.6 | 10.0 | 9.94 | 97.60 ± 0.53 | 99.34 ± 0.02 |
| 7-3 | 17.0 | 52.7 | 10.3 | 20.0 | 10.75 | 97.75 ± 0.19 | 99.36 ± 0.04 |

### Example 8

In this example, electrolytes were prepared and tested similar to Example 1 except that the compositions are shown in Table 9. Diethylene glycol dimethyl ether (DGL) has a boiling point of 162° C.

TABLE 9
Electrolyte compositions according to some
embodiments of the present disclosure

| Ex. | LiFSI | EmimFSI | DGL | IC | Initial | Average |
|---|---|---|---|---|---|---|
| No. | (wt %) | (wt %) | (wt %) | (mS/cm) | CE, % | CE, % |
| 8-1 | 37.4 | 50.1 | 12.5 | 5.09 | 96.43 ± 0.71 | 99.20 ± 0.08 |

As shown in Table 9, the electrolyte example 8-1 exhibits an ionic conductivity of 5.09 mS/cm. Lithium metal battery comprising the electrolyte exhibits an average CE of 99.20%.

### Example 9

In this example, electrolytes were prepared and tested similar to Example 1 except that the compositions are shown in Table 10. Note that DEE and tris(2,2,2-trifluoroethyl) phosphite (TFEPi, a boiling point of around 130-131° C. at 743 mmHg) are used as mixture solvent.

TABLE 10
Electrolyte compositions according to some
embodiments of the present disclosure

| Ex. | LiFSI | EmimFSI | DEE | TFEPi | IC | Initial | Average |
|---|---|---|---|---|---|---|---|
| No. | (wt %) | (wt %) | (wt %) | (wt %) | (mS/cm) | CE, % | CE, % |
| 9-1 | 33.7 | 45.1 | 11.2 | 10.0 | 7.03 | 95.67 ± 0.99 | 99.09 ± 0.08 |

As shown in Table 10, the electrolyte example 9-1 exhibits an IC of 7.03 mS/cm. Lithium metal battery comprising the electrolyte exhibits an average CE of 99.09%.

### Example 10

In this example, electrolytes were prepared and tested similar to Example 1 except that the compositions are shown in Table 11. The solvent diethyl sebacate (DES) has a boiling point of around 312° C.

TABLE 11
Electrolyte compositions according to some
embodiments of the present disclosure

| Ex. | LiFSI | EmimFSI | DES | IC | Initial | Average |
|---|---|---|---|---|---|---|
| No. | (wt %) | (wt %) | (wt %) | (mS/cm) | CE, % | CE, % |
| 10-1 | 37.4 | 50.1 | 12.5 | 3.13 | 92.65 ± 0.82 | 98.77 ± 0.04 |

As shown in Table 11, the electrolyte example 10-1 exhibits an ionic conductivity of 3.13 mS/cm. Lithium metal battery comprising the electrolyte exhibits an average coulombic efficiency (CE) of 98.77%.

### Example 11

In this example, electrolytes were prepared and tested similar to Example 1 except that the compositions are shown in Table 12. The solvent N,N-diethyltrifluoromethanesulfonamide (ETSA) has a boiling point of 178-180° C.

TABLE 12
Electrolyte compositions according to some
embodiments of the present disclosure

| Ex. | LiFSI | EmimFSI | ETSA | IC | Initial | Average |
|---|---|---|---|---|---|---|
| No. | (wt %) | (wt %) | (wt %) | (mS/cm) | CE, % | CE, % |
| 11-1 | 37.4 | 50.1 | 12.5 | 3.14 | 97.66 ± 0.48 | 99.36 ± 0.04 |

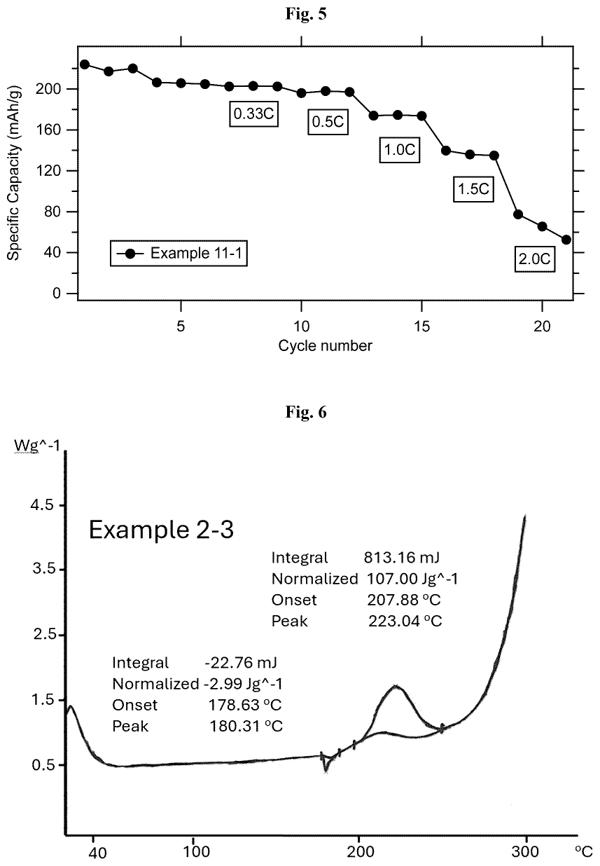

As shown in Table 12, the electrolyte example 11-1 exhibits an ionic conductivity of 3.14 mS/cm. Lithium metal battery comprising the electrolyte exhibits an average Coulombic efficiency (CE) of 99.36%. FIG. 5 shows the specific capacities at various charge rates (1.0 C=3.0 mA/cm², up to 6.0 mA/cm²) of a coin cell comprising Li metal as anode, NMC811 composite electrode as cathode, microporous membrane as separator, and an electrolyte of Example 11-1 (Ex. No. 11-1).

### Example 12

In this example, electrolyte was prepared and tested similar to Example 1 except that the composition is shown in Table 13. The solvent 1,2-(1,1,2,2-tetrafluoroethoxy)ethane (TFEE) has a boiling point of 141° C.

TABLE 13
Electrolyte composition according to some embodiments of the present disclosure

| Ex. | LiFSI | EmimFSI | TFEE | IC | Initial | Average |
|---|---|---|---|---|---|---|
| No. | (wt %) | (wt %) | (wt %) | (mS/cm) | CE, % | CE, % |
| 12-1 | 30.0 | 50.0 | 20.0 | 7.24 | 96.48 ± 1.59 | 99.15 ± 0.10 |

As shown in Table 13, the electrolyte example 12-1 exhibits an ionic conductivity of 7.24 mS/cm. Lithium metal battery comprising the electrolyte exhibits an average Coulombic efficiency (CE) of 99.15%.

### Example 13

In this example, electrolytes were prepared and tested similar to Example 1 except that the compositions are shown in Table 14. Note that the solvent is DEE and the non-imidazolium ionic liquid is N-propyl-N-methylpyrrolidinium bis(fluorosulfonyl)imide (PYR13FSI).

As shown in Table 14, the electrolytes of examples 13-1 and 13-2 exhibit an ionic conductivity of 5.56 mS/cm and 5.72 mS/cm, respectively. Lithium metal batteries comprising the electrolytes exhibit an average coulombic efficiency (CE) of 99.37% and 99.14%, respectively.

TABLE 14
Electrolyte compositions according to some embodiments of the present disclosure

| Ex. | LiFSI | EmimFSI | DEE | PYR13FSI | IC | Initial | Average |
|---|---|---|---|---|---|---|---|
| No. | (wt %) | (wt %) | (wt %) | (wt %) | (mS/cm) | CE, % | CE, % |
| 13-1 | 37.4 | 25.0 | 12.6 | 25.0 | 5.56 | 95.98 ± 0.35 | 99.37 ± 0.06 |
| 13-2 | 37.4 | 26.9 | 10.3 | 25.4 | 5.72 | 97.65 ± 1.01 | 99.14 ± 0.01 |

### Example 14

In this example, electrolyte was prepared and tested similar to Example 1 except that the composition is shown in Table 15. Note that the solvent is DEE and the non-imidazolium ionic liquid is 1-methyl-1-(2-methoxyethyl)pyrrolidinium bis(fluorosulfonyl)imide (PYOFSI).

As shown in Table 15, the electrolyte of example 14-1 exhibits an ionic conductivity of 5.72 mS/cm. Lithium metal batteries comprising the electrolytes exhibit an average coulombic efficiency (CE) of 99.33%.

TABLE 15
Electrolyte compositions according to some embodiments of the present disclosure

| Ex. | LiFSI | EmimFSI | DEE | PYOFSI | IC | Initial | Average |
|---|---|---|---|---|---|---|---|
| No. | (wt %) | (wt %) | (wt %) | (wt %) | (mS/cm) | CE, % | CE, % |
| 14-1 | 37.4 | 25.0 | 12.6 | 25.0 | 5.72 | 95.90 ± 0.26 | 99.33 ± 0.03 |

### Example 15

An electrolyte comprising a polymer was prepared by mixing Example 2-3 as base electrolyte, pentaerythritol tetraacrylate (PETA) as monomer, and AIBN as initiator followed by polymerization at 65° C. The composition of the polymer electrolyte is shown in Table 16.

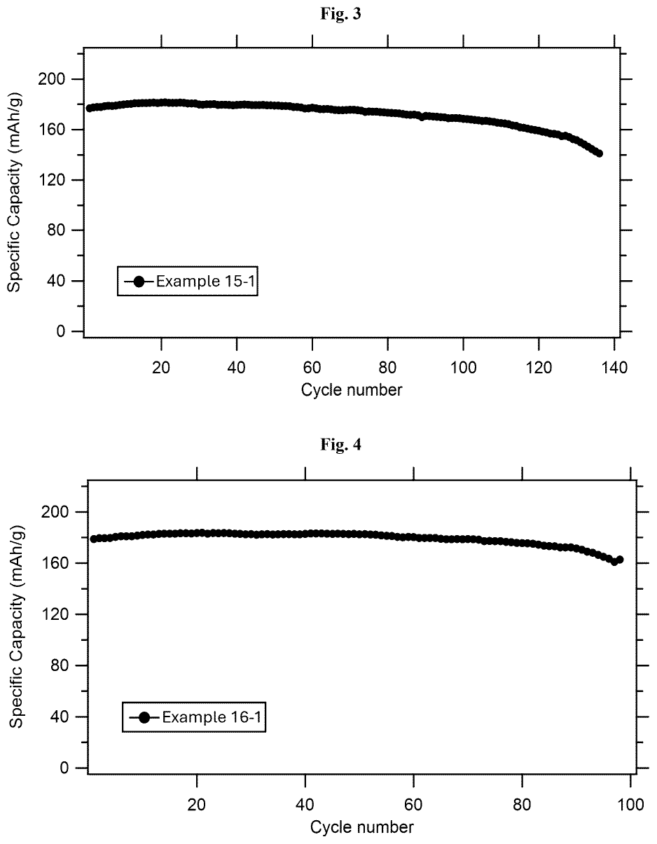

A multi-layer pouch cell (0.75 Ah) comprising Li metal as anode, microporous membrane as separator, NMC811 as cathode, and polymer electrolyte example 15-1 (Ex. No. 15-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity of the pouch cell is shown in FIG. 3. The cell was cycled until capacity drops below 80% of initial capacity.

TABLE 16
Electrolyte composition of polymer
electrolyte based on Example 2-3

| Ex. No. | Example 2-3 (wt %) | PETA (wt %) | AIBN (wt %) |
|---|---|---|---|
| 15-1 | 98.35 | 1.50 | 0.15 |

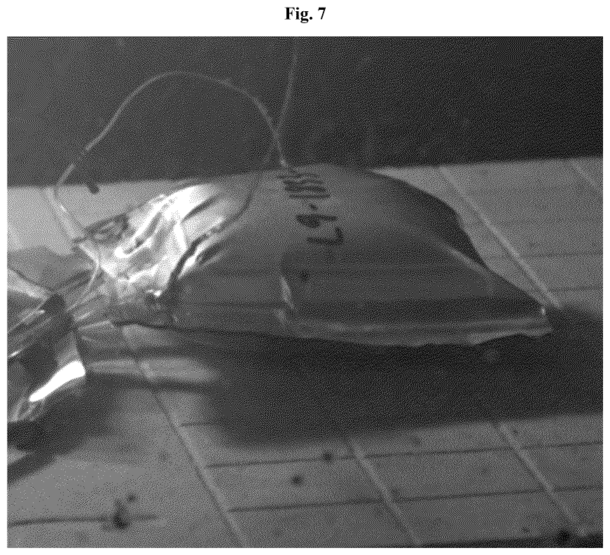

A hot box test was also conducted on a pouch cell (1.65 Ah) comprising lithium metal anode, NMC811 composite electrode as cathode, microporous membrane as separator, and the electrolyte (example 15-1) by placing the fully charged cell into an oven and gradually increasing the temperature of the cell from room temperature to 190° C. at a rate of 5° C./minute. During the heating process, the temperature of the cell was temporarily held for 10 minutes at each of the following temperatures: 130° C., 140° C., 150° C., 160° C., 170° C., 180° C., and 190° C. The cell reached an EUCAR hazard level of 3. After the hot box test, there was no fire or explosion as shown in FIG. 7 and the weight loss of the cell was less than 50 wt % of total weight of electrolyte in the cell. Both the DSC analysis of the electrolyte and the hot box test of the cell suggest the improved thermal stability and safety of the cell.

### Example 16

An electrolyte comprising a polymer was prepared by mixing Example 6-1 as base electrolyte, pentaerythritol tetraacrylate (PETA) as monomer, and AIBN as initiator followed by polymerization at 65° C. The composition of the polymer electrolyte is shown in Table 17.

A multi-layer pouch cell (0.75 Ah) comprising Li metal as anode, microporous membrane as separator, NMC811 as cathode, and polymer electrolyte example 16-1 (Ex. No. 16-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity of the pouch cell is shown in FIG. 4. The cell was cycled until capacity drops below 80% of initial capacity.

TABLE 17
Electrolyte composition of polymer
electrolyte based on Example 6-1

| Ex. No. | Example 6-1 (wt %) | PETA (wt %) | AIBN (wt %) |
|---|---|---|---|
| 16-1 | 98.35 | 1.50 | 0.15 |

### Aspects

In a first aspect, the present disclosure provides an electrolyte comprising lithium salt, an imidazolium ionic liquid, and an organic solvent with a boiling point of 100° C. or higher.

In a second aspect according to the first aspect, the imidazolium ionic liquid has a formula of

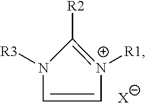

where R1 and R3 are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and combinations thereof, R2 is independently selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and where X⁻ is an anion.

In a third aspect according to the second aspect, the anion X⁻ is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

In a fourth aspect according to any preceding aspect, the organic solvent is free of ionic structure.

In a fifth aspect according to any preceding aspect, the lithium salt and the imidazolium ionic liquid share the same anion.

In a sixth aspect according to any preceding aspect, the organic solvent is selected from the group consisting of 1,2-diethoxyethane (DEE), 1,2-dipropoxyethane (DPE), dibutyl ether (DBE), anisole (AN), diethylene glycol dimethyl ether (DGL), triethylene glycol dimethyl ether (triglyme), tetraethylene glycol dimethyl ether (tetraglyme), 1-fluoronaphthalene (FNP), tris(2,2,2-trifluoroethyl), bis(2,2,2-trifluoroethoxy)methane (BTFM), N,N-dimethyltrifluoromethanesulfonamide (DTSA), N,N-diethyltrifluoromethanesulfonamide (ETSA), 1,2-(1,1,2,2-tetrafluoroethoxy)ethane (TFEE), 1,2-bis(2,2-difluoroethoxy)ethane (BDFE), 2-[2-(2,2-difluoroethoxy)ethoxy]-1,1,1-trifluoroethane (DTFE), tris(2,2,2-trifluoroethyl)orthoformate (TFEO), 1H,1H,5H-octafluoropentyl 1,1,2,2-tetrafluoroethyl ether (OTE), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

In a seventh aspect according to any preceding aspect, the organic solvent has a weight percentage in a range from 5 wt % to 50 wt % in the electrolyte.

In an eighth aspect according to any preceding aspect, the lithium salt is selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}Hz)₆₋ₓ]) (1<x<5, 1<y<8, and 0<z<2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and mixtures thereof

In a nineth aspect according to any preceding aspect, the lithium salt has a weight percentage in a range from 10 wt % to 50 wt % in the electrolyte.

In a tenth aspect according to any preceding aspect, the imidazolium ionic liquid is selected from the group consisting of 1-ethyl-3-methylimidazolium bis(fluorosulfonyl)imide (EmimFSI), 1-butyl-3-methylimidazolium bis(fluorosulfonyl)imide (BmimFSI), 1-hexyl-3-methylimidazolium bis(fluorosulfonyl)imide (HmimFSI), 1-vinyl-3-methylimidazolium bis(fluorosulfonyl)imide (VmimFSI), 1-ethyl-3-methylimidazolium bis(trifluoromethanesulfonyl)imide (EmimTFSI), 1-butyl-3-methylimidazolium bis(trifluoromethanesulfonyl)imide (BmimTFSI), 1-hexyl-3-methylimidazolium bis(trifluoromethanesulfonyl)imide (HmimTFSI), 1-vinyl-3-methylimidazolium bis(trifluoromethanesulfonyl)imide (VmimTFSI), and mixtures thereof.

In an eleventh aspect according to any preceding aspect, the imidazolium ionic liquid has a weight percentage in a range from 30 wt % to 80 wt % in the electrolyte.

In a twelfth aspect according to any preceding aspect, the electrolyte further comprises a polymer.

In a thirteenth aspect according to the twelfth aspect, the polymer has a weight percentage in a range from 0.02 wt % to 40 wt % in the electrolyte.

In a fourteenth aspect according to the twelfth or thirteenth aspect, the polymer is in situ polymerized after mixing a monomer with the lithium salt, the imidazolium ionic liquid and the organic solvent.

In a fifteenth aspect according to the fourteenth aspect, the monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=700), triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, and dipentaerythritol hexaacrylate.

In a sixteenth aspect according to any preceding aspect, the electrolyte further comprises an additive with a weight percentage of 20 wt % or less.

In a seventeenth aspect according to the sixteenth aspect, the additive has a boiling point of no higher than 100° C.

In an eighteenth aspect according to any of the first through the fifteenth aspects, the electrolyte does not include any solvent that has a boiling point less than 100° C.

In a nineteenth aspect according to any of the first through the fifteenth aspects, each component in the electrolyte has a boiling point of at least 100° C., at least 105° C., or at least 110° C.

In a twentieth aspect according to any of the first through the fifteenth aspects, the electrolyte does not exhibit any exothermic or endothermic peak in a differential scanning calorimetry (DSC) curve from room temperature to 100° C.

In a twenty-first aspect according to any preceding aspect, the electrolyte exhibits an ionic conductivity of at least 3.0 mS/cm at room temperature.

In a twenty-second aspect, the present disclosure provides an electrochemical device comprising the electrolyte according to any preceding aspect.

In a twenty-third aspect according to the twenty-second aspect, the electrochemical device exhibits an average Coulombic efficiency of at least 98.0%.

In a twenty-fourth aspect according to the twenty-second or twenty-third aspect, the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.

In a twenty-fifth aspect according to any of the twenty-second through twenty-fourth aspects, the electrochemical device does not experience leakage of the electrolyte after a hot box test, wherein the hot box test is conducted by placing the electrochemical device at 100% state-of-charge into an oven and increasing the temperature of the cell from room temperature to 190° C. with a holding of 10 minutes at each of the following temperatures: 130° C., 140° C., 150° C., 160° C., 170° C., 180° C., and 190° C.

In a twenty-sixth aspect according to any of the twenty-second through twenty-fifth aspects, the electrochemical device does not explode after a hot box test, wherein the hot box test is conducted by placing the electrochemical device at 100% state-of-charge into an oven and increasing the temperature of the cell from room temperature to 190° C. with a holding of 10 minutes at each of the following temperatures: 130° C., 140° C., 150° C., 160° C., 170° C., 180° C., and 190° C.

In a twenty-seventh aspect according to any of the twenty-second through twenty-sixth aspects, the electrochemical device experiences a weight loss of 50% or less of the total weight of electrolyte in the device after a hotbox test, wherein the hot box test is conducted by placing the electrochemical device at 100% state-of-charge into an oven and increasing the temperature of the cell from room temperature to 190° C. with a holding of 10 minutes at each of the following temperatures: 130° C., 140° C., 150° C., 160° C., 170° C., 180° C., and 190° C.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

1-15. (canceled)

16. An electrolyte comprising:
a) a lithium salt;
b) an imidazolium ionic liquid; and
c) an organic solvent with a boiling point of 100° C. or higher, wherein the organic solvent is free of ionic structure.

17. The electrolyte of claim 16, wherein the imidazolium ionic liquid has a formula of 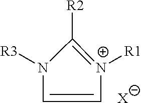
where R1 and R3 are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and combinations thereof, R2 is selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and combinations thereof, and where X⁻ is an anion.

18. The electrolyte of claim 17, wherein the anion X⁻ is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

19. The electrolyte of claim 16, wherein the lithium salt and the imidazolium ionic liquid share the same anion.

20. The electrolyte of claim 16, wherein the organic solvent is free of ionic structure.

21. The electrolyte of claim 16, wherein the organic solvent is selected from the group consisting of 1,2-diethoxyethane (DEE), 1,2-dipropoxyethane (DPE), dibutyl ether (DBE), anisole (AN), diethylene glycol dimethyl ether (DGL), triethylene glycol dimethyl ether (triglyme), tetraethylene glycol dimethyl ether (tetraglyme), 1-fluoronaphthalene (FNP), tris(2,2,2-trifluoroethyl), bis(2,2,2-trifluoroethoxy)methane (BTFM), N,N-dimethyltrifluoromethanesulfonamide (DTSA), N,N-diethyltrifluoromethanesulfonamide (ETSA), 1,2-(1,1,2,2-tetrafluoroethoxy)ethane (TFEE), 1,2-bis(2,2-difluoroethoxy)ethane (BDFE), 2-[2-(2,2-difluoroethoxy)ethoxy]-1,1,1-trifluoroethane (DTFE), tris(2,2,2-trifluoroethyl)orthoformate (TFEO), 1H,1H,5H-octafluoropentyl 1,1,2,2-tetrafluoroethyl ether (OTE), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

22. The electrolyte of claim 16, wherein the organic solvent has a weight percentage in a range from 5 wt % to 50 wt % in the electrolyte.

23. The electrolyte of claim 16, wherein the lithium salt is selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}Hz)₆₋ₓ]) (1<x<5, 1<y<8, and 0<z<2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and mixtures thereof

24. The electrolyte of claim 16, wherein the lithium salt has a weight percentage in a range from 10 wt % to 50 wt % in the electrolyte.

25. The electrolyte of claim 16, wherein the imidazolium ionic liquid is selected from the group consisting of 1-ethyl-3-methylimidazolium bis(fluorosulfonyl)imide (EmimFSI), 1-butyl-3-methylimidazolium bis(fluorosulfonyl)imide (BmimFSI), 1-hexyl-3-methylimidazolium bis(fluorosulfonyl)imide (HmimFSI), 1-vinyl-3-methylimidazolium bis(fluorosulfonyl)imide (VmimFSI), 1-ethyl-3-methylimidazolium bis(trifluoromethanesulfonyl)imide (EmimTFSI), 1-butyl-3-methylimidazolium bis(trifluoromethanesulfonyl)imide (BmimTFSI), 1-hexyl-3-methylimidazolium bis(trifluoromethanesulfonyl)imide (HmimTFSI), 1-vinyl-3-methylimidazolium bis(trifluoromethanesulfonyl)imide (VmimTFSI), and mixtures thereof.

26. The electrolyte of claim 16, wherein the imidazolium ionic liquid has a weight percentage in a range from 30 wt % to 80 wt % in the electrolyte.

27. The electrolyte of claim 16, further comprising a polymer with a weight percentage in a range from 0.02 wt % to 40 wt % in the electrolyte, wherein the polymer is obtained by an in situ polymerization of a monomer after mixing with the lithium salt, the imidazolium ionic liquid and the organic solvent.

28. The electrolyte of claim 27, wherein the monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=500-5000 Daltons), triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, and dipentaerythritol hexaacrylate.

29. The electrolyte of claim 16, wherein the electrolyte does not include any component with a boiling point of less than 100° C. at 1 atm.

30. The electrolyte of claim 16, wherein each component in the electrolyte has a boiling point of at least 110° C.

31. The electrolyte of claim 16, wherein the electrolyte does not exhibit any exothermic or endothermic peak in a differential scanning calorimetry (DSC) curve from room temperature to 100° C.

32. The electrolyte of claim 16, wherein the electrolyte exhibits an ionic conductivity of at least 3.0 mS/cm at room temperature.

33. An electrochemical device comprising the electrolyte of claim 16.

34. The electrochemical device of claim 33, wherein the electrochemical device exhibits an average Coulombic efficiency of at least 98.0%.

35. The electrochemical device of claim 33, wherein the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.
